(19) United States
(12) Patent Application Publication
(10) Pub. No.: US 2006/0199609 A1
(43) Pub. Date: Sep. 7, 2006

(54) Threat phone: camera-phone automation for personal safety

(76) Inventor: Barrett Jerome Gay, Fairburn, GA (US)

Correspondence Address: Barrett J. Gay, 7133 Joshua Way, Fairburn, GA, 30213, US

(21) Appl. No.: 11/068,449

(22) Filed: Feb. 28, 2005

(51) Int. Cl. H04M 1/00

(52) U.S. Cl. 455/556.1

(57) ABSTRACT

This invention is a wireless personal safety apparatus incorporating camera/digital phones (or wireless transceiver capable of recording and transmitting digital photos); and Global Positioning Satellite (GPS) applications in wireless communication; U.S. classes 403; 404.1, 437 and international class H04L.

### BACKGROUND

1. Field of Invention

This invention relates to camera/digital phones (or wireless transceiver capable of recording/transmitting digital photos); Global Positioning Satellite (GPS) applications; and handheld wireless safety alarms.

2. Description of Prior Art

Personal safety is a fundamental need shared by everyone (“Maslow Effect”). Use of safety products or self-defense tactics present unique challenges such as courage, concentration, skills (training) and fast reaction-fundamentals not shared by everyone (“Fight, Flight or Freeze Syndrome”). Existing camera phone functions are based on standard camera principle(s) of aim, shoot, and press button for result. Essentially, it is an added feature. Existing camera phone operations have no automated or “hands-free” capabilities, which make it difficult for this instrument to instantly record and transmit data. “Hands-free” or safety improvements for wireless products are predicated on motorist or road safety concerns. Hence, increased demand for adaptable earpiece-microphone units.

General Motor's “On-Star” incorporates GPS and wireless communication in its emergency response service to motorists, but this interface does not apply to pedestrians. Nor does it provide visual imagery-a critical advantage in reporting emergencies or threats. Wireless electronic safety products, for pedestrians or anyone performing outdoor activities, is limited to handheld devices that emit loud sounds. These noises can not validate a threat through audio-image capturing; provide incident location; and/or automatically report this collected data to proper authorities. Safety implementations for wireless communication are aimed at motor vehicle operation; and personal safety products, as a whole, is too reactive (not proactive).

Moreover, no wireless transceiver or handheld safety instrument deters unwanted advances/solicitations by automatically reporting accurate accounts of an incident based on camera-phone and GPS applications. Provisional Patent Application No. 60/548,797 for “Threat Phone” was granted by USPTO to applicant Barrett J. Gay, Fairburn, Ga. under “Small Entity” status on Mar. 1, 2004.

Objects and Advantages

In addition to limitations of camera-phones identified above, objects and advantages of expanding/interfacing GPS-camera phones in this invention are:
(a) to create a “hands free” adjustable miniature opaque lens¹ capable of capturing wide view angle of targets (eliminating need to “aim and shoot”), connected by cable wire to transceiver's circuit board;
   ¹ Opaque lens prevents flashlights from being used to defeat instrument's objective.
(b) to mold miniature opaque lens with or into “paper binder” style clip enabling this adjustable component to clamp to user's outer garment;
(c) to create a handheld transmitter connected by cable wire to transceiver's circuit board that activates automated process of collecting and transmitting digital pictures and audio from incident scene;
(d) to permanently set camera in “continuous-shooting” mode enabling unit to capture maximum photos before transmitting them;
(e) to include beeping light/indicator on lens casing indicating “ready mode”;
(f) to activate microphone in conjunction with picture taking function;
(g) to scramble/zip captured image, audio and GPS data (to prevent abuse or privacy concerns);
(h) to transmit/route visual audio data obtained from threat to a remote location for verification and police notification; and
(i) transmit scrambled/zipped data to a secondary emergency camera phone number (i.e., friend) programmed by user during initial setup;
(j) to specify unit's GPS remain active (to accurately indicate incident location);
(k) to store transmitted visual-audio and GPS data at remote location for police use only;
(l) to program/script wireless transceiver's operating system (OS) software with above functions with press of a single button. Specifically overriding any existing transceiver activities (i.e., talking).
   Developing Threat Phones

Threat Phone's basic hardware design consists of two novelties: detachable opaque lens with a clamp; and a handheld transmitter. As an option, the former novel component can be integrated with an earpiece, minus the clamp. Both basic components connect to transceiver's circuit board by cable wires. The lens must contain a clamping mechanism allowing it to be fastened to outer garment; and must be opaque to prevent excess light from entering camera. Same lens must have a light indicator to alert others that unit is in threat mode. Upon pressing transmitter, threat mode will override any transceiver activities (i.e. phone conversation) and initiate process of collecting audio-visual data from scene and transmitting it a remote monitoring service ala “On-Star”.

Software Requirements for Threat Phones

OS software can allow user option of manually programming emergency data for remote storage (i.e. emergency contact, blood type and photo). This would allow remote monitoring service to wirelessly transmit this critical data to police responding to alert scene-valuable function if user is non-responsive or missing. To prevent abuse/privacy issues, incident data recorded by Threat Phones must be stored remotely, not inside the transceiver. However, silhouette or coded records can be stored therein in a date-time activity log format. Collected audio, image and GPS data should be scrambled/zipped and transmitted to a remote processing location and emergency contact for assessment. If user fails to enter a PIN indicating he/she is okay, user should receive an audio message or alert indicating they have activated their alarm and police may be summoned to the scene.

A non-response to this “false alarm” safeguard by user will result in full automated threat mode which includes remote monitoring service notifying police and providing them with visual images, audio and GPS details from scene, in addition to user's personal data. With exception of analysis by remote monitoring service, audio and visual data obtained from alert scene should remain scrambled or zipped until incident is reported to police (maintaining privacy integrity).

### DRAWING FIGURES

FIGS. 1A to 1C depict 1 of 2 designs for Threat Phone's adjustable “hands-free” lens positioning necessary to acquire unobstructed view of intruding object.

FIGS. 2A to 2B depict handheld transmitter/activation device.

FIGS. 3A to 3C depict optional earpiece model of FIGS. 1A and 1B functions, minus garment clamp.

### REFERENCE NUMERALS IN DRAWINGS

1A adjustable lens with opaque filter to prevent excess light from entering.
1B cable connects lens to transceiver's circuit board (not shown).
1C clamp to secure lens to user's outer garment.
2A cable connects to transceiver circuit board (not shown).
3A optional earpiece platform (for lens positioning)
3B protruding tubular lens casing.
3C cable connects to transceiver's circuit board (not shown).

### SUMMARY

In accordance with the present invention, Threat Phone's hardware novelty consists of an adjustable/adaptable opaque lens which connects to user's outer garment and a handheld transmitter/activation instrument. The lens can also be integrated with an earpiece-microphone accessory to yield unobstructed view of target object.

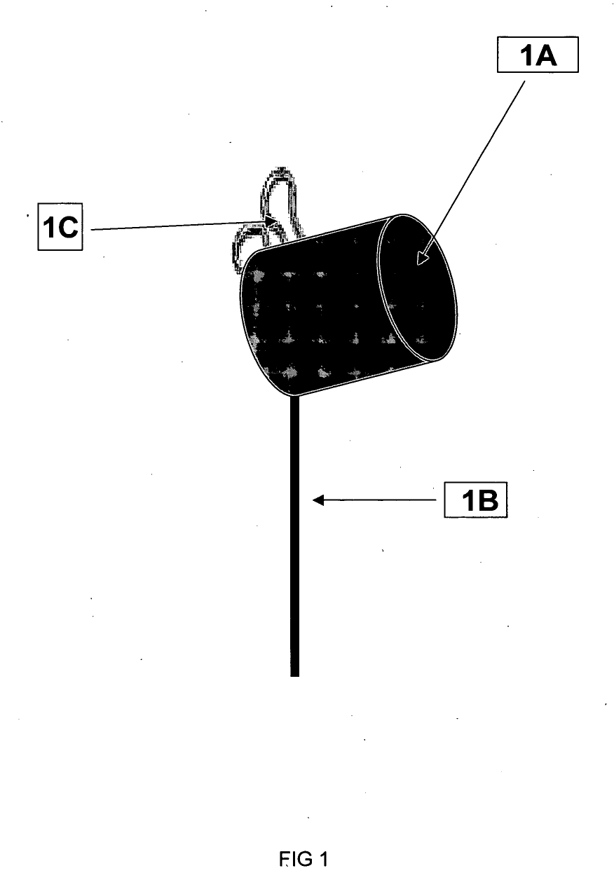

Description—FIGS. 1 to 3.

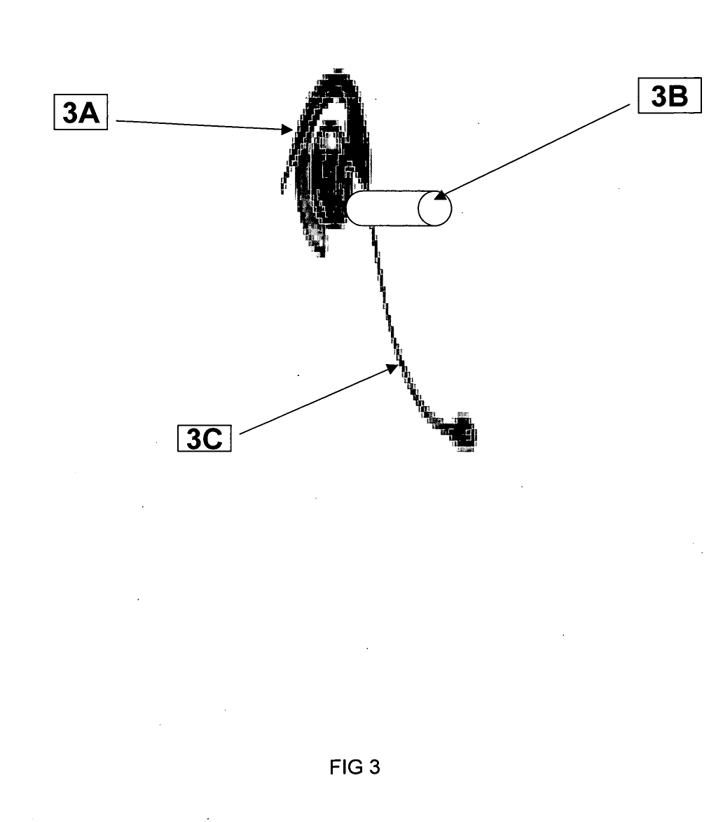

FIGS. 1 and 3 depict lens platform positioning critical to Threat Phone's operability.

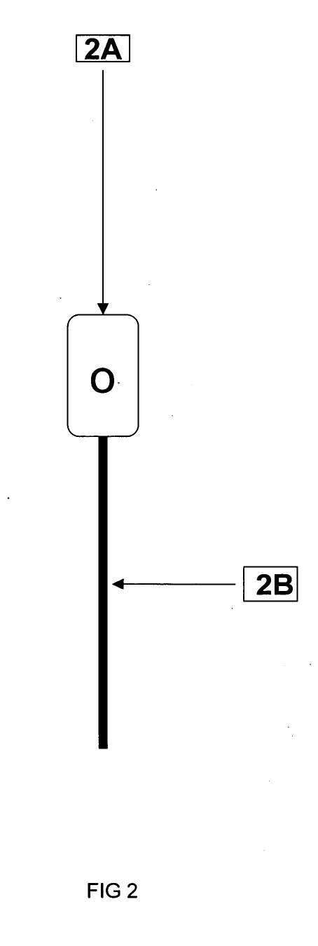

FIG. 2 is a handheld transmitter that activates automated process of collecting and transmitting visual-audio and GPS data from incident scene (with press of a single button).

Operation—FIGS. 1 to 3.

The manner of using Threat Phone varies from existing camera phones (or hands-free accessories) and handheld electronic safety products. Camera phones are manually controlled and not constructed for instant image capturing. Additionally, they lack automated capabilities of collecting and transmitting image, audio, and GPS data.

Upon clamping lens to outer garment or applying optional earpiece version (FIGS. 1 and 2), connecting cable wires should be plugged into transceiver's circuit board. This insert will result in a flashing light/indicator on or near lens to alert Threat Phone is in active mode. Upon pressing handheld transmitter, Threat Phone overrides any transceiver activities (i.e. talking) and activates the following automated functions (in accordance to unit's OS software scripting/programming):
Sets camera in “continuous-shooting” mode enabling unit to capture maximum photos before transmitting them;
Automatically activates microphone to capture audio noises from incident scene;
Record unit's GPS data;
Scramble/zip visual-audio and GPS data (to prevent abuse or privacy concerns);
Simultaneously transmit scrambled image-audio and GPS data to remote receiver;
Transmit scrambled visual, audio and GPS data to a secondary phone number (i.e. friend) programmed by user during initial setup;
Decoding software at receiving end (remote location) to evaluate and relay to police, if necessary;

### CONCLUSION, RAMIFICATIONS, AND SCOPE

Accordingly, the reader will see that by adding a handheld transmitter and repositioning critical lens component, camera phones can be improved significantly. Threat Phone's OS software capture, scramble and transmit “image, audio and GPS data”. To prevent privacy concerns, this collected data should not be stored inside transceiver. Upon activation, automated data processing will override any phone activities. Invention's opaque lens prevents flashlights from being used as a countermeasure to distort image data.

Although the descriptions name herein describes many specifications, these should not be construed as liming the scope of the invention, but as merely providing illustrations of some of the presently preferred embodiments of this invention. For example, the lens and/or its platform used to capture unobstructed view of an object can have other shapes; or be integrated with an earpiece microphone/speaker accessory. Transmitted image, audio and GPS data does not have to immediately undergo human analysis at receiving end. This collected data can be stored to a server for a limited time period (remaining scrambled or zipped) until police is notified.

Thus, the scope of the invention should be determined by the appended claims and their legal equivalents, rather than by the examples given.

1. Hardware aspects of this invention are predicated on lens repositioning (and opaqueness); operating in conjunction with a handheld transmitter activator. Threat Phone is not a stand-alone apparatus, but an automated feature capable of being incorporated into existing wireless communication products. This unit's OS software must be programmed or scripted with following instructions after handheld transmitter is pressed:
Override existing wireless communication activities (i.e. conversations);
Audio/flash alert to user or others indicating unit is in “threat mode”;
Engage unit's camera and microphone;
Set camera in “continuous shooting” mode;
Capture visual and audio data from scene;
Record unit's GPS location;
Transmit collected digital image, audio and GPS data to remote receiver; and
Scramble/zip collected image, audio and GPS data.
